(19) United States
(12) Patent Application Publication
(10) Pub. No.: US 2026/0159660 A1
(43) Pub. Date: Jun. 11, 2026

(54) MELAMINE RESIN FOAMS BY OXIDATION REACTION

(71) Applicant: BASF SE, Ludwigshafen am Rhein (DE)

(72) Inventors: Bernhard VATH, Ludwigshafen (DE); Alexander KOENIG, Ludwigshafen (DE)

(73) Assignee: BASF SE, Ludwigshafen am Rhein (DE)

(21) Appl. No.: 19/126,759

(22) PCT Filed: Oct. 27, 2023
(86) PCT No.: PCT/EP2023/080056

§ 371 Date: May 2, 2025

(30) Foreign Application Priority Data
Nov. 3, 2022 (EP) 22205324.1

(51) Int. Cl. C08J 9/00; C08J 9/06; C08J 9/14

(52) U.S. Cl. CPC C08J 9/0023; C08J 9/06; C08J 9/141; C08J 9/146; C08J 2203/184; C08J 2361/28

(57) ABSTRACT

The present invention relates to a process for producing a melamine resin foam, comprising foaming an aqueous mixture M, said mixture M comprising at least one melamine-formaldehyde precondensate, an aqueous hydrogen peroxide solution, and at least one surfactant.

The present invention relates to a process for producing a melamine resin foam, comprising foaming an aqueous mixture M, said mixture M comprising at least one melamine-formaldehyde precondensate, an aqueous hydrogen peroxide solution, and at least one surfactant.

Melamine resin foams are used for different applications, such as sound absorption, for instance in acoustic rooms, and thermal insulation, for example in buildings and pipe insulation. In the state of the art, melamine foams are commonly prepared by reacting a melamine-formaldehyde precondensate with an acid as curing agent. Furthermore, typically, a physical blowing agent, such a hydrocarbons, and in particular pentane, are used. Since the afore-mentioned reaction shows a rather low exothermicity, in the state of the art the reaction/foaming mixture is usually heated in order to ensure the curing and foaming of the resin. Heating according to the state of the art is carried out using an external heat source, such as microwave radiation or hot air.

However, the application of external heat and especially microwave radiation as described in the prior art and commonly applied to produce melamine resin foams may be a disadvantage, since it is, for instance, challenging to keep the microwave power constant during the course of the production.

Moreover, hydrocarbons used as physical blowing agents, such as in particular pentane as described in the prior art, are burnable and may easily lead to the formation of an explosive atmosphere. Therefore, a high level of safety equipment and procedures are necessary in the production of the described melamine resin foams according to the state of the art.

DE 29 15 467 (A1) relates to the preparation of a resilient foam based on a melamine/formaldehyde condensate by foaming an aqueous solution or dispersion, which contains a melamine/formaldehyde precondensate, an emulsifier, a volatile blowing agent and a curing agent. As curing agent, organic and inorganic acids are disclosed. Foaming of the mixture is carried out in a hot air atmosphere at 150° C. DE 29 15 467 (A1) does not disclose a process comprising an aqueous hydrogen peroxide solution, in which excessive heating during foaming can be avoided.

CN 109 836 548 (A) discloses a method for preparing a melamine-based foam, comprising the preparation of a melamine, paraformaldehyde and water mixture, the use of n-pentane as blowing agent, an organic acid as curing agent and heating in a microwave oven during foaming. CN 109 836 548 A does not disclose a process comprising an aqueous hydrogen peroxide solution, in which microwave heating during foaming can be avoided nor a n-pentane-free process.

EP 3 750 952 (A1) relates to a process for producing melamine-formaldehyde foams using fluorinated blowing agents, said process comprising heating and foaming a mixture comprising at least one melamine-formaldehyde precondensate, at least one curative, at least one surfactant and a blowing agent mixture. The curing agent is an acidic compound that catalyses the condensation selected from inorganic or organic acids and the blowing agent comprises 5 to 20% by weight of a fluorinated ether and 80 to 95% by weight of a hydrocarbon such as pentane. The precondensate is foamed up by heating the mixture using microwave radiation. EP 3 750 952 (A1) does not disclose a process comprising an aqueous hydrogen peroxide solution, in which microwave heating during foaming can be avoided nor a n-pentane-free process.

WO 2018/098056 (A1) relates to a cleaning implement that includes a melamine-formaldehyde foam for hard surface cleaning, such as tiles, showers, and sinks, including a method for producing the foam. A mixture comprising melamine-formaldehyde precondensate, at least one linear polymer, a curative, a dispersant, and a blowing agent are heated up to foam either by means of hot air or high frequency irradiation. The curative may either be an inorganic or an organic acid. An active agent for cleaning surfaces may be impregnated into the foam, such as a mixture of a surfactant, a biocide, a bleaching agent, a limescale reducing agent, an agent for removing greasy stains and the like. WO 2018/098056 (A1) does not disclose the preparation of a melamine resin foam comprising foaming at least one melamine-formaldehyde precondensate, an aqueous hydrogen peroxide solution and at least one surfactant according to the inventive process.

WO 2014/172357 (A1) relates to a cleaning article including a melamine-formaldehyde foam comprising hollow microspheres for removing soil and stains from hard surfaces. An active agent for cleaning surfaces may be included into the microspheres and impregnated into the foam, such as a mixture of a surfactant, a biocide, a bleaching agent, a limescale reducing agent, an agent for removing greasy stains and the like. WO 2014/172357 (A1) does not disclose the preparation of a melamine resin foam comprising foaming at least one melamine-formaldehyde precondensate, an aqueous hydrogen peroxide solution and at least one surfactant according to the inventive process.

WO 2019/060647 (A1) relates to a cleaning article including a melamine-formaldehyde foam for removing soil and stains from hard surfaces. An active agent for cleaning surfaces may be impregnated into the foam, such as a mixture of a surfactant, a biocide, a bleaching agent, a limescale reducing agent, an agent for removing greasy stains and the like. WO 2019/060647 (A1) does not disclose the preparation of a melamine resin foam comprising foaming at least one melamine-formaldehyde precondensate, an aqueous hydrogen peroxide solution and at least one surfactant according to the inventive process.

U.S. Pat. No. 3,864,137 relates to the production of foams by mixing aqueous silicate solutions with hydrogen peroxide as blowing agent resulting in structures consisting substantially of silicates, which may also contain inorganic or organic fillers. U.S. Pat. No. 3,864,137 does not disclose the preparation of a melamine resin foam according to the inventive process.

CN 103 553 700 (A) relates to an environmentally friendly magnesium oxide material, where the raw material for foaming contains 80 to 90% by weight of burned magnesium powder, a filler, and a composite foaming agent, where the composite foaming agent may contain 20 to 40% by weight of a peroxide. The raw material may also contain an organic or inorganic filler, such as zeolite, fly ash, and/or waste tire rubber and 5 to 10% by weight of a melamine resin. CN 103 553 700 A does not disclose the preparation of a melamine resin foam comprising foaming at least one melamine-formaldehyde precondensate, an aqueous hydrogen peroxide solution and at least one surfactant according to the inventive process.

CN 102 603 353 (A) relates to a foaming agent for foaming concrete, comprising 35 to 45% by weight of hydrogen peroxide. CN 102 603 353 (A) does not disclose any melamine resin foam or a process according to the inventive process.

CN 110 372 995 (A) relates to an environmentally friendly modified melamine-formaldehyde-melamine resin foam material obtained from a mixture of the following parts by weight of raw materials: 65-80 parts of modified melamine-formaldehyde melamine resin; 3-6 parts of foam stabilizer; 0.2-2 parts of foaming agent, 20-35 parts of functional powder; 0.2-0.5 parts of dispersant; 0.3-0.6 parts of accelerator and 2-5 parts of curing agent. The foaming agent preferably comprises industrial hydrogen peroxide and aluminum powder. The process according to CN 110 372 995 (A) is disadvantageous since it is based on the mandatory use of powders, in particular high amounts of functional powders and/or aluminum powder as foaming agent. Such powders provoke the formation of (higher amounts of) hydrogen, due to the reaction with hydrogen peroxide, which is problematic in respect of safety considerations. Beyond that, the process according to CN 110 372 995 (A) requires the use of acids such as sulfuric acid, hydrochloric acid, phosphoric acid, oxalic acid, acetic acid, and acrylic acid.

The object of the present invention is to provide a novel process for producing a melamine resin foam. Furthermore, the novel process should have beneficial properties with regard to avoiding excessive external heating or the use of microwave radiation, in particular in connection with burnable/explosive hydrocarbon blowing agents.

This object is achieved by a process for producing a melamine resin foam, comprising foaming an aqueous mixture M, said mixture M comprising at least one melamine-formaldehyde precondensate, an aqueous hydrogen peroxide solution and at least one surfactant.

The inventive process may be used to produce melamine resin foams, for instance for thermal insulation applications or acoustic absorption and thermal insulation applications. By using the inventive process, certain disadvantages of the processes to produce melamine resin foams disclosed in the prior art can be avoided.

Surprisingly, it has been found that by applying the inventive process, external heating as described in the prior art, such as by using microwave radiation or hot air, can be avoided.

Beyond that, it has surprisingly been found that by applying the inventive process, a melamine resin foam can be produced without the addition of a physical blowing agent, such as a hydrocarbon, e.g. pentane, or at least by a significant reduction of the amount of added physical blowing agent. Thus, an advantage of the inventive process is that the presence of a burnable/explosive physical blowing agent, such as pentane during curing by external heating or radiation by microwaves can be avoided or at least the concentration of such physical blowing agent can be lowered significantly.

A further advantage of the inventive process can be seen in the fact that in the inventive process, no curing agent/catalyst, in the form of an acid, in particular formic acid as applied in the state of the art needs to be added.

Furthermore, the inventive process leads to melamine resin foams with a low shore hardness, which may be useful for some applications. In particular, foams showing a low shore hardness are of high interest for thermal insulation applications.

The invention is specified in more detail as follows:

The invention relates to a process for producing a melamine resin foam, comprising foaming an aqueous mixture M, said mixture M comprising at least one melamine-formaldehyde precondensate, an aqueous hydrogen peroxide solution and at least one surfactant.

Foaming of melamine-formaldehyde precondensate in order to obtain a melamine resin foam as such is known to the person skilled in the art. The same holds true for melamine-precondensates as such.

The melamine-formaldehyde precondensates may be prepared separately or commercially available precondensates of the two components, melamine and formaldehyde, may be used.

Preferably,
a) the melamine-formaldehyde precondensate has a molar ratio of melamine to formaldehyde ranging from 1:5 to 1:1.3 [mol/mol], preferably from 1:3.5 to 1:1.5 [mol/mol], and/or
b) the number average molecular weight Mₙ of the melamine-formaldehyde precondensate ranges from 200 g/mol to 1000 g/mol (determined by gel permeation chromatography).

Preference is given to unmodified melamine-formaldehyde precondensates.

The person skilled in the art knows how to determine the average molecular weight (number average) of such melamine-formaldehyde precondensates. For instance, this can be done using gel permeation chromatography. The preparation and characterization of such melamine-formaldehyde precondensates is, e.g., described in “W. Woebang, Kunststoffhandbuch 10^{th} Duroplaste, Munich, Vienna, 1988”, “Encyclopedia of Polymer Science and Technology, 3^{rd} Edition, Vol. 1 Chapter 1, amino resins, pp. 340 to 370, 2003”, or “Ullmann's Encyclopedia of Industrial Chemistry, 6^{th} Edition, Vol. 2, Chapter 3, amino resins, pp. 537 to 565, Weinheim, 2003”.

Moreover, it is preferred within the invention that the mixture M comprises 30 to 90% by weight of the at least one melamine-formaldehyde precondensate, based on the total weight of the mixture M, preferably 40 to 80% by weight of the melamine-formaldehyde precondensate, based on the total weight of the mixture M, more preferably 51 to 75% by weight of the melamine-formaldehyde precondensate, based on the total weight of the mixture M.

Hydrogen peroxide and aqueous hydrogen peroxide solutions are known to the person skilled in the art.

Within the present invention, it is preferred that
a) the aqueous hydrogen peroxide solution comprises (about) 3 to 50% by weight, preferably (about) 6 to 37% by weight, more preferably (about) 25 to 35% by weight of hydrogen peroxide, based on the total weight of the hydrogen peroxide solution.

Hydrogen peroxide as such as well as hydrogen peroxide solutions in water, alcohol, or ether are known to the person skilled in the art.

Within the inventive process, hydrogen peroxide is preferably applied as aqueous solution of about 3 to 50% by weight of hydrogen peroxide, preferably about 6 to 37% by weight of hydrogen peroxide, more preferably about 25 to 35% by weight of hydrogen peroxide, based on the total weight of the hydrogen peroxide solution.

Furthermore, according to the present invention it is preferred that the mixture M comprises 0.5 to 10% by weight of hydrogen peroxide as contained in the aqueous hydrogen peroxide solution, based on the total weight of the mixture M, preferably 1 to 7.5% by weight of hydrogen peroxide, based on the total weight of the mixture M.

Surfactants as such are known to a person skilled in the art. According to the present invention, anionic, cationic and nonionic surfactants and also mixtures thereof can be used as dispersant/emulsifier.

Useful anionic surfactants include for example diphenylene oxide sulfonates, alkane and alkylbenzenesulfonates, alkylnaphthalenesulfonates, olefinsulfonates, alkyl ether sulfonates, fatty alcohol sulfates, ether sulfates, α-sulfo fatty acid esters, acylaminoalkanesulfonates, acyl isethionates, alkyl ether carboxylates, N-acylsarcosinates, alkyl and alkylether phosphates.

Useful nonionic surfactants include alkylphenol polyglycol ethers, fatty alcohol polyglycol ethers, fatty acid polyglycol ethers, fatty acid alkanolamides, ethylene oxide-propylene oxide block copolymers, amine oxides, glycerol fatty acid esters, sorbitan esters and alkylpolyglycosides.

Useful cationic emulsifiers include for example alkyltriammonium salts, alkylbenzyldimethylammonium salts and alkylpyridinium salts.

According to the inventive process it is preferred that,
a) the at least one surfactant is an anionic surfactant, preferably the at least one surfactant is an anionic surfactant chosen from the group of diphenylene oxide sulfonates, alkane and alkylbenzenesulfonates, alkylnaphthalenesulfonates, olefinsulfonates, alkyl ether sulfonates, fatty alcohol sulfates, ether sulfates, α-sulfo fatty acid esters, acylaminoalkanesulfonates, acyl isethionates, alkyl ether carboxylates, N-acylsarcosinates, alkyl and alkylether phosphates, or
b) the at least one surfactant is a nonionic surfactant, preferably the at least one surfactant is a nonionic surfactant chosen from the group of alkylphenol polyglycol ethers, fatty alcohol polyglycol ethers, fatty acid polyglycol ethers, fatty acid alkanolamides, ethylene oxide-propylene oxide block copolymers, amine oxides, glycerol fatty acid esters, sorbitan esters and alkylpolyglycoside, and/or
c) the at least one surfactant is a surfactant mixture of i) 50 to 90% by weight of at least one anionic surfactant, preferably the at least one surfactant is an anionic surfactant chosen from the group of diphenylene oxide sulfonates, alkane and alkylbenzenesulfonates, alkylnaphthalenesulfonates, olefinsulfonates, alkyl ether sulfonates, fatty alcohol sulfates, ether sulfates, α-sulfo fatty acid esters, acylaminoalkanesulfonates, acyl isethionates, alkyl ether carboxylates, N-acylsarcosinates, alkyl and alkylether phosphates and ii) 10 to 50% by weight of at least one non-ionic surfactant, based on the total weight of the surfactant mixture, wherein the at least one nonionic surfactant is preferably chosen from the group of alkylphenol polyglycol ethers, fatty alcohol polyglycol ethers, fatty acid polyglycol ethers, fatty acid alkanolamides, ethylene oxide-propylene oxide block copolymers, amine oxides, glycerol fatty acid esters, sorbitan esters and alkylpolyglycoside.

Furthermore, it is preferred that the mixture M comprises 0.5 to 10% by weight of the at least one surfactant, based on the total weight of the mixture M, preferably 1 to 7.5% by weight of the at least one surfactant, based on the total weight of the mixture M.

Within the process of the present invention, the mixture M may contain, as an optional component, additionally at least one blowing agent. Blowing agents as such are known to a person skilled in the art.

Within the process of the present invention,
a) preferably, the blowing agent is at least one physical blowing agent
   i) chosen from the group of hydrocarbons, preferably chosen from the group of C₅-C₇ hydrocarbons or halogenated hydrocarbons, more preferably chosen from the group of chlorinated or fluorinated hydrocarbons, and/or
   ii) chosen from the group of alcohols, ethers, ketons and ester, and/or
b) the blowing agent has a boiling point between 0 and 80° C., and/or
c) the mixture M comprises 0.5 to 30% by weight of the blowing agent, based on the total weight of the mixture M, preferably 1.5 to 20% by weight of the blowing agent, based on the total weight of the mixture M.

Physical blowing agents are known to the person skilled in the art and described, for example, in Encyclopedia of Polymer Science and Technology, Vol. I, 3rd ed., Additives, pages 203 to 218, 2003.

Useful physical blowing agents include, for example, hydrocarbons, such as butane, n-, iso- or cyclo-pentane, hexane, halogenated, more particularly chlorinated and/or fluorinated hydrocarbons, for example, methylene chloride, chloroform, trichloroethane, chlorofluorocarbons, hydrochlorofluorocarbons (HCFCs), hydrofluorocarbons (HCFs) like methylnonafluorbutylether, ethylnonofluorbutylether, hydrofluoroolefins (HFOs) like hexafluorobutene, alcohols, for example, methanol, ethanol, n-propanol or isopropanol, ethers, ketones and esters, for example methyl formate, ethyl formate, methyl acetate or ethyl acetate. Preferred physical blowing agents are those having a boiling point of between 0 and 80° C.

According to the inventive process, it is preferred that the additional blowing agent is a fluorinated ether.

Moreover, according to the inventive process, it is preferred that the additional blowing agent is a hydro-fluoro-olefin. More preferably, the hydro-fluoro-olefin is trans-1-chloro-3,3,3-trifluoropropene.

The amount of blowing agent in the mixture generally depends on the desired density for the foam. Preferably the amount in relation to the melamine-formaldehyde precondensate is chosen in an amount that the density of the foam is 5 to 150 kg/m³, more preferably 10 to 100 kg/m³, most preferably 12.5 to 75 kg/m³.

Moreover, in another embodiment of the present invention, it is preferred that additional water is added to the mixture M, wherein 1 to 30% by weight of additional water is added, based on the total weight of the mixture M after the addition of water, preferable 5 to 25% by weight of additional water, based on the total weight of the mixture M after the addition of water.

Within the present invention it is preferred that the mixture M does not comprise i) any functional powders, in particular no calcium carbonate powder and no calcined kaolin, ii) any aluminum powders and/or iii) any accelerators, in particular no aqueous cobalt naphthenate, no aqueous cobalt isooctanoate, and no aqueous potassium isooctanoate.

Within the context of the present invention the term “the mixture M does not comprise any” means that the mixture M contains the respective component in an amount of less than 0.01% by weight (based on the total weight of the mixture M), preferably in an amount of less than 0.001% by weight, more preferably in an amount of less than 0.0001% by weight, most preferably the mixture M is entirely free of said component (less than 100 ppm).

In a further embodiment of the present invention, the mixture M comprises
a) 30 to 90% by weight of the at least one melamine-formaldehyde precondensate, based on the total weight of the mixture M, preferably 40 to 80% by weight of the melamine-formaldehyde precondensate, based on the total weight of the mixture M, more preferably 51 to 75% by weight of the melamine-formaldehyde precondensate, based on the total weight of the mixture M, and/or
b) 0.5 to 10% by weight of hydrogen peroxide as contained in the aqueous hydrogen peroxide solution, based on the total weight of the mixture M, preferably 1 to 7.5% by weight of hydrogen peroxide as contained in the aqueous hydrogen peroxide solution, based on the total weight of the mixture M, and/or
c) 0.5 to 10% by weight of the at least one surfactant, based on the total weight of the mixture M, preferably 1 to 7.5% by weight of the at least one surfactant, based on the total weight of the mixture M, and/or
d) optionally, 0 to 40% by weight of a blowing agent, based on the total weight of the mixture M, preferably 0.5 to 30% by weight of a blowing agent, based on the total weight of the mixture M, and/or
e) 1 to 69% by weight of additional water as contained within the aqueous hydrogen peroxide solution and/or added additionally, based on the total weight of the mixture M.

It is clear to a person skilled in the art that the sum of the percentages by weight of the components comprised within the mixture M in general add up to 100% by weight.

It is more preferred within this embodiment of the present invention that the at least one surfactant is a surfactant mixture of i) 50 to 90% by weight of at least one anionic surfactant, preferably the at least one surfactant is an anionic surfactant chosen from the group of diphenylene oxide sulfonates, alkane and alkylbenzenesulfonates, alkylnaphthalenesulfonates, olefinsulfonates, alkyl ether sulfonates, fatty alcohol sulfates, ether sulfates, α-sulfo fatty acid esters, acylaminoalkanesulfonates, acyl isethionates, alkyl ether carboxylates, N-acylsarcosinates, alkyl and alkylether phosphates and ii) 10 to 50% by weight of at least one non-ionic surfactant, based on the total weight of the surfactant mixture, wherein the at least one nonionic surfactant is preferably chosen from the group of alkylphenol polyglycol ethers, fatty alcohol polyglycol ethers, fatty acid polyglycol ethers, fatty acid alkanolamides, ethylene oxide-propylene oxide block copolymers, amine oxides, glycerol fatty acid esters, sorbitan esters and alkylpolyglycoside.

It is even more preferred within this embodiment of the present invention that the mixture M does not comprise i) any functional powders, in particular no calcium carbonate powder and no calcined kaolin, ii) any aluminum powders and/or iii) any accelerators, in particular no aqueous cobalt naphthenate, no aqueous cobalt isooctanoate, and no aqueous potassium isooctanoate.

According to one embodiment of the present invention, it is especially preferred that the mixture M comprises
a) 51 to 75% by weight of the melamine-formaldehyde precondensate, based on the total weight of the mixture M,
b) 0.5 to 10% by weight of hydrogen peroxide as contained in the aqueous hydrogen peroxide solution, based on the total weight of the mixture M, preferably 1 to 7.5% by weight of hydrogen peroxide as contained in the aqueous hydrogen peroxide solution, based on the total weight of the mixture M, and/or
c) 1 to 7.5% by weight of the at least one surfactant, based on the total weight of the mixture M, and/or
d) optionally, 0 to 40% by weight of a blowing agent, based on the total weight of the mixture M, and/or
e) 1 to 69% by weight of additional water as contained within the aqueous hydrogen peroxide solution and/or added additionally, based on the total weight of the mixture M.

It is clear to a person skilled in the art that the sum of the percentages by weight of the components comprised within the mixture M in general add up to 100% by weight.

It is more preferred within this embodiment of the present invention that the at least one surfactant is a surfactant mixture of i) 50 to 90% by weight of at least one anionic surfactant, preferably the at least one surfactant is an anionic surfactant chosen from the group of diphenylene oxide sulfonates, alkane and alkylbenzenesulfonates, alkylnaphthalenesulfonates, olefinsulfonates, alkyl ether sulfonates, fatty alcohol sulfates, ether sulfates, α-sulfo fatty acid esters, acylaminoalkanesulfonates, acyl isethionates, alkyl ether carboxylates, N-acylsarcosinates, alkyl and alkylether phosphates and ii) 10 to 50% by weight of at least one non-ionic surfactant, based on the total weight of the surfactant mixture, wherein the at least one nonionic surfactant is preferably chosen from the group of alkylphenol polyglycol ethers, fatty alcohol polyglycol ethers, fatty acid polyglycol ethers, fatty acid alkanolamides, ethylene oxide-propylene oxide block copolymers, amine oxides, glycerol fatty acid esters, sorbitan esters and alkylpolyglycoside.

It is even more preferred within this embodiment of the present invention that the mixture M does not comprise i) any functional powders, in particular no calcium carbonate powder and no calcined kaolin, ii) any aluminum powders and/or iii) any accelerators, in particular no aqueous cobalt naphthenate, no aqueous cobalt isooctanoate, and no aqueous potassium isooctanoate.

Furthermore, the mixture M according to the present invention may optionally comprise at least one halogen-free flame retardant. At least one halogen-free flame retardant means one halogen-free flame retardant or mixtures of two or more halogen-free flame retardants. The at least one halogen-free flame retardant may be solid or liquid. Halogen-free flame retardants are generally added to the mixture M before foaming or applied as coating after foam preparation.

Halogen-free flame retardants are known to the person skilled in the art. For instance, halogen-free flame retardants are disclosed in the European patent application no. 21200402.2-1107.

The halogen-free flame retardants are preferably present in a total amount of 0.5 to 40% by weight, more preferably in a total amount of 2.5 to 25% by weight, most preferably in a total amount of 5 to 20% by weight, based on the melamine resin foam.

In a further embodiment, the mixture M is free of silicates. In the context of the present invention, the term “free of silicates” means that the mixture contains no more than 1% by weight of a silicate, based on the total amount of the mixture M, in another embodiment no more than 0.1% by weight of a silicate based on the total amount of the mixture M and in a further embodiment the mixture M contains essentially no silicate such as no silicate at all.

In a further embodiment, no acidic compounds are added to the mixture M as curatives to catalyse the further condensation of the melamine resin. Preferably, no acidic compounds chosen from the group consisting of formic acid, hydrochloric acid, sulfuric acid, phosphoric acid, nitric acid, acetic acid, oxalic acid, toluene sulfonic acids, amido sulfonic acids, acid anhydrides and mixtures thereof are added to the mixture M. Most preferably, no formic acid is added to the mixture M.

In a further embodiment according to the present invention, it is preferred that the melamine resin foam has a bulk density in the range from 5 to 150 kg/m³, more preferably 10 to 100 kg/m³, and most preferably 12.5 to 75 kg/m³.

The person skilled in the art knows how to determine/measure the respective density. This can be done by the method according to DIN EN ISO 845:2009.

In a further embodiment according to the present invention, it is preferred that the melamine resin foam has a shore hardness of 10 to 100, more preferably 10 to 60.

The person skilled in the art knows how to determine/measure the respective shore hardness. This can, for instance, be done by the method according to: ASTM D2240:2015. According to the present invention, for the measurement of low density foams the scale of 000 was used (2.4 mm diameter of the sphere, spring force 1.111 N).

The foamed materials produced can be finally dried, removing residual water and blowing agent from the foam. Drying is carried out preferably in a drying oven at a temperature in the range of 40 to 200° C., particularly preferably 100 to 150° C. until a constant weight. The process described provides blocks or slabs of foamed material, which can be cut to size in any desired shapes.

The melamine resin foam prepared by the method according to the invention may be post-treated by the following methods:
1. Thermocompression to obtain foams with higher density, better durability, and cleaning behavior. These foams can be produced according to EP2922901.
2. Hydrophobation to obtain foams with lower water uptake and
3. Optionally impregnation with flame retardants to further improve the FST properties (Flame, Smoke, Toxicity) in the case of fire.

Hydrophilization by impregnation with a fluorocarbon resin and/or silicon resin and additional impregnation with flame-retardant substances, such as silicates, borate, hydroxides or phosphates can be achieved as described in WO 2007/023118.

In a further preferred embodiment of the present invention, the process for producing a melamine foam comprises the steps:
a) Adding, at a temperature between 50 to 80° C., the at least one melamine-formaldehyde precondensate, hydrogen peroxide solution, the at least one surfactant, optionally additional water and optionally the at least one blowing agent to obtain an aqueous mixture M,
b) foaming the aqueous mixture M at a temperature between 50 to 80° C.,
c) optionally, tempering the resulting foam from step b) for 50 to 70 min at 50 to 80° C.

Another subject of the present invention is a melamine resin foam, obtainable by a process as defined in detail above.

Another subject of the present invention is the use of the melamine resin foam obtained by the process as described in detail above for acoustic and/or thermal insulation, building and construction, furniture and cushioning applications, packaging applications, cleaning applications, filters and/or agricultural applications.

In particular, the melamine resin foam obtained by the inventive process may be used in building and/or construction, i.e. for cushioning and furniture in leisure or office environments like seats, sofas, mattresses or transportation in train, aircraft and automotive in seats, headrests, and armrests. Further applications are in packaging, i.e. packaging material to protect delivering good, cleaning applications, such as cleaning sponges, floor pads, hand pads, as filter medium or in acoustic applications in building and/or construction, such as sound absorbers in room acoustics for offices, schools, restaurants, noise chambers, furniture, separation walls, acoustic elements in walls and ceilings as well as silencer in air conditioning or transportation applications, such as sound absorber in automotive, under the hood motor for noise reduction or indoor as headliner, sun visor, or hat rack. Further applications include thermal insulation in industrial applications, such as pipe insulation or insulation of air conditioning devices or for wall and roof insulation in building and/or construction. Applications in agriculture include growing substrate and floral foams.

The present invention is explained in more detail below by examples, but is not restricted thereto.

### EXAMPLES

In the following, the present invention is described in more detail and specifically with reference to the examples, which are, however, not meant to limit the present invention.

### Methods

### Shore Hardness

The measurements were run according to ASTM D 2240-15. For the measurement of low density foams the scale of 000 was used (2.4 mm diameter of the sphere, spring force 1.111 N).

### Density

The measurements were run according to DIN EN ISO 845-2009.

### Materials

MF Melamine-formaldehyde precondensate having an average molecular weight (number average) M of 350 g/mol, with a molar ratio of melamine:formaldehyde of 1:3, which apart from melamine comprised no further thermoset-formers and apart from formaldehyde comprised no further aldehydes and which was sulfite group free.
SM Surfactant Mixture: Hostapur SAS-30, Clariant/Lutensol AT80, BASF in the ratio 80/20
30 wt.-% aqueous H₂O₂ solution, Sigma Aldrich
Trans-1-chloro-3,3,3-trifluoropropene, pentane

### Comparative Examples 1-14

### C1

225 of a spray-dried melamine-formaldehyde precondensate, MF, (molar ratio 1:3) were dissolved in 90 g water, then 3.375 g of a Surfactant Mixture: Hostapur SAS-30, Clariant/Lutensol AT80, BASF in the ratio 80/20, 6.75 g of sodium formiate, and 6.85 g of formic acid and 6 g of pentane were mixed at a temperature of 20 to 35° C. The mixture was subsequently introduced into a polypropylene mold for foaming and irradiated in a microwave oven with microwave energy. After the foaming is completed, the bodies obtained were annealed in a circulating air oven at 200° C. for 20 min.

### C2-C14

Samples C2 to C14 were prepared according to the procedure described in detail for C1, but with varying pentane content as can be seen in Table 1.

TABLE 1
Comparative examples C1-C14

| # | Pentane/g | Density/kg/m³ | Shore Hardness 000 |
|---|---|---|---|
| C1 | 6 | 45 | 112 |
| C2 | 7 | 42.5 | 99 |
| C3 | 8 | 40 | 99 |
| C4 | 9 | 37.5 | 93 |
| C5 | 10 | 35 | 88 |
| C6 | 11 | 32.5 | 86 |
| C7 | 12 | 30 | 84 |
| C8 | 13 | 27.5 | 83 |
| C9 | 14 | 25 | 81 |
| C10 | 16 | 22.5 | 70 |
| C11 | 17 | 20 | 68 |
| C12 | 18 | 17.5 | 67 |
| C13 | 22 | 15 | 63 |
| C14 | 30 | 12.5 | 52 |

### Inventive Examples 11-118

### I1

In a temperature-controlled 10-L-glass vessel of 60° C., 35 g of the solid MF resin, 7.5 g water, 7 g of the 30 wt.-% hydrogen peroxide solution, 2 g of the Surfactant Mixture SM were mixed and stirred for 30 s. The atmosphere in the vessel was flowed by nitrogen. After a few minutes the foaming started. The resulting foam was kept for 60 min in the 60° C. vessel to cure completely. Afterwards the foam was removed from the vessel applying a demolding release agent.

### I2-I5

Samples I2 to I5 were prepared according to the procedure described in detail for I1, but with varying content of the hydrogen peroxide solution as can be seen in Table 2.

### I6

In a temperature-controlled 10-L-glass vessel of 60° C., 35 g of the solid MF resin, 7.5 g water, 11 g of the 30 wt.-% hydrogen peroxide solution, 2 g of the Surfactant Mixture SM, and 1 g of the HFO blowing agent were mixed and stirred for 30 s. The atmosphere in the vessel was flowed by nitrogen. After a few minutes the foaming started. The resulting foam was kept for 60 min in the 60° C. vessel to cure completely. Afterwards the foam was removed from the vessel applying a demolding release agent.

### I7-I18

Samples I7 to I18 were prepared according to the procedure described in detail for I6, but with varying content of the hydrogen peroxide solution and HFO blowing agent as can be seen in Table 2.

TABLE 2
Inventive Examples

| | 30 wt.-% H₂O₂ | HFO blowing | Density/ | Shore Hardness |
|---|---|---|---|---|
| # | solution/g | agent/g | kg/m³ | 000 |
| I1 | 7 | 0 | 94 | 95 |
| I2 | 8 | 0 | 78 | 88 |
| I3 | 9 | 0 | 72 | 76 |
| I4 | 10 | 0 | 65 | 72 |
| I5 | 11 | 0 | 56 | 59 |
| I6 | 11 | 1 | 44 | 52 |
| I7 | 11 | 2 | 34 | 46 |
| I8 | 11 | 3 | 33 | 44 |
| I9 | 11 | 4 | 28 | 39 |
| I10 | 11 | 5 | 27 | 39 |
| I11 | 11 | 6 | 25 | 37 |
| I12 | 11 | 7 | 23 | 34 |
| I13 | 11 | 8 | 21 | 32 |
| I14 | 11 | 9 | 20 | 29 |
| I15 | 11 | 10 | 17 | 27 |
| I16 | 11 | 11 | 16 | 26 |
| I17 | 11 | 12 | 12 | 23 |
| I18 | 11 | 13 | 11 | 22 |

As can be seen from Tables 1 and 2, the inventive process leads to values for the density and shore hardness comparable to the comparative examples, however, according to the inventive process it is not necessary to apply pentane and microwave heating.

1. A process for producing a melamine resin foam, comprising foaming an aqueous mixture M, the mixture M comprising at least one melamine-formaldehyde precondensate, an aqueous hydrogen peroxide solution, and at least one surfactant.

2. The process according to claim 1, wherein:
a) the melamine-formaldehyde precondensate has a molar ratio of melamine to formaldehyde of 1:5 to 1:1.3 [mol/mol]; and/or
b) a number average molecular weight Mₙ of the melamine-formaldehyde precondensate is 200 g/mol to 1000 g/mol (determined by gel permeation chromatography).

3. The process according to claim 1, wherein the aqueous hydrogen peroxide solution comprises 3 to 50% by weight of hydrogen peroxide, based on a total weight of the aqueous hydrogen peroxide solution.

4. The process according to claim 1, wherein
a) the at least one surfactant is an anionic surfactant; or
b) the at least one surfactant is a nonionic surfactant; and/or
c) the at least one surfactant is a surfactant mixture of 50 to 90% by weight of at least one anionic surfactant and 10 to 50% by weight of at least one non-ionic surfactant, based on a total weight of the surfactant mixture.

5. The process according to claim 1, wherein the mixture M comprises an additional blowing agent, wherein:
a) the blowing agent is at least one physical blowing agent selected from the group consisting of a hydrocarbon, an alcohol, and ether, a ketone, and an ester; and/or
b) the blowing agent has a boiling point of 0 to 80° C.; and/or
c) the mixture M comprises 0.5 to 30% by weight of the blowing agent, based on a total weight of the mixture M.

6. The process according to claim 1, wherein:
additional water is added to the mixture M, and
1 to 30% by weight of additional water is added, based on the total weight of the mixture M after the addition of water.

7. The process according to claim 1, wherein the mixture M is free of formic acid, hydrochloric acid, sulfuric acid, phosphoric acid, nitric acid, acetic acid, oxalic acid, toluene sulfonic acids, amido sulfonic acids, and acid anhydrides.

8. The process according to claim 1, wherein the mixture M comprises:
a) 30 to 90% by weight of the at least one melamine-formaldehyde precondensate, based on a total weight of the mixture M; and/or
b) 0.5 to 10% by weight of hydrogen peroxide as contained in the aqueous hydrogen peroxide solution, based on the total weight of the mixture M; and/or
c) 0.5 to 10% by weight of the at least one surfactant, based on the total weight of the mixture M; and/or
d) 0 to 40% by weight of a blowing agent, based on the total weight of the mixture M; and/or
e) 1 to 69% by weight of additional water as contained within the aqueous hydrogen peroxide solution and/or added additionally, based on the total weight of the mixture M.

9. The process according to claim 1, wherein the mixture M is free of: i) functional powders, ii) aluminum powders, and iii) accelerators.

10. The process according to claim 1, wherein the melamine resin foam has a bulk density of 5 to 150 kg/m³.

11. The process according to claim 1, wherein the melamine resin foam has a shore hardness (determined according to: ASTM D2240:2015) of 10 to 100.

12. The process according to claim 1, comprising:
a) combining, at a temperature of 50 to 80° C., the at least one melamine-formaldehyde precondensate, the aqueous hydrogen peroxide solution, the at least one surfactant, optionally additional water, and optionally at least one blowing agent to obtain the aqueous mixture M,
b) foaming the aqueous mixture M at a temperature of 50 to 80° C.,
c) optionally, tempering a foam obtained in b) for 50 to 70 min at 50 to 80° C.

13. A melamine resin foam, obtained by the process according to claim 1.

14. The melamine resin foam according to claim 15, wherein the foam is in a form selected from the group consisting of acoustic insulation, thermal insulation, a building or construction component, a furniture or cushioning component, packaging, a cleaning product, a filter, and an agricultural product.
